(19) United States
(12) Patent Application Publication
(10) Pub. No.: US 2011/0259110 A1
(43) Pub. Date: Oct. 27, 2011

(54) Device for Measuring Strain in a Component

(76) Inventor: Christopher P. Smith, Woodstock, GA (US)

(21) Appl. No.: 12/982,095

(22) Filed: Dec. 30, 2010

Related U.S. Application Data
(60) Provisional application No. 61/335,149, filed on Dec. 31, 2009.

(51) Int. Cl. G01L 1/00; G01N 19/06

(52) U.S. Cl. 73/760; 73/783

(57) ABSTRACT

Disclosed is an apparatus and method for measuring the diametral change in a cylindrical component by monitoring and measuring bending (compression and tension) effected by the diametral change in a plane perpendicular to the diameter of the cylindrical component. The apparatus for effecting the method comprises at least one web, but typically two webs, defining planes perpendicular to the diameter of the cylindrical component and strain measuring elements mounted on the web planes and arranged to sense and measure the compressive and tensile (bending) action of the strain-gauge-mounted webs.

### CROSS REFERENCE TO RELATED APPLICATIONS

This application claims the benefit of the filing date of U.S. Provisional Application No. 61/335,149, filed Dec. 31, 2009.

### BACKGROUND

The present disclosure relates to a device that measures strain in a component and more particularly to a device that measures diametral strain in a cylindrical component and the measurements are used to calculate the load and stress within the cylindrical component.

In many industries, it is important to measure the variable dynamic or static axial loads that may be imposed on a cylindrical member or shaft. This is especially true in the nuclear power industry where motor operated valves are used extensively. Monitoring of the various operating parameters of the valves is required by the nuclear power regulating agencies. Motor operated valves are comprised generally of an electric motor driven actuator that is connected to a valve stem and a valve yoke that partially surrounds the valve stem.

It has been observed that one of the ways to monitor certain dynamic forces and events that occur during the operation of a valve is by measurement of the valve stem axial loads using either axial or diametral extensometers.

It is known that one can calculate the axial load or stress in a valve stem, or any other similar member, by measuring changes in the diameter of the valve stem. The ratio of the diametral change to axial elongation, referred to as Poisson's ratio, is known and available for most materials. Therefore, by measuring the diametral changes in the valve stem using a device such as a diametral extensometer, axial strains and valve stem axial loads can be easily calculated and determined. However, the sensitivity and stability of current extensometer designs are often lacking in order to achieve accurate readings.

### SUMMARY OF THE DISCLOSURE

The entire contents of U.S. provisional patent application 61/335,149, to which priority is claimed above, is hereby incorporated herein by reference.

The present disclosure is directed to a strain measuring device that senses diametral changes in a cylindrical component and measures such diametral change using strain sensing elements arranged on a frame of the strain measuring device. The strain sensing elements may measure tensile and compressive strain developed in the frame as a result of the frame flexing via diametral growth of the component.

Briefly described, the strain measuring device comprises a rigid frame. Generally, the frame has an outer surface and an inner surface spaced from the outer surface in a radial direction. The frame also has a planar first side surface generally parallel to and spaced from a planar second side surface. The rigid frame may be an arcuate frame or a “C” shaped frame. The strain measuring device may further comprise a first contact assembly arranged at, or near, an end of the frame and a second contact assembly arranged on an opposite end of the frame. A passage extends through the frame along an axis that is substantially parallel with a longitudinal axis and the passage arranged on the frame between the first contact assembly and the second contact assembly. An inner web is defined between the passage and the inner surface of the frame and an outer web is defined between and the outer surface of the frame and the passage. The strain measuring device further comprises at least a first strain sensing element contacting either the inner web or the outer web. In some embodiments, the strain measuring device may comprise a second strain sensing element contacting the web not contacted by the first strain sensing element. The strain sensing elements may be mounted to the webs of the frame to measure substantially pure tensile and compressive strains developed in the frame as a result of the diametral growth of the component.

In another embodiment, the strain measuring device may comprise a body defining a first mounting portion and a second mounting portion spaced apart and interconnected by a central body portion. A first clamp head may be mounted to the first mounting portion, for engagement with a shaft. A second clamp head may be mounted to the second mounting portion, for engagement with a shaft, and spaced from the first clamp head. The first clamp head and said second clamp head are aligned along and spaced apart along a common centerline that does not intersect said central body portion. A passage extends through said central body portion and is proximate either the first clamp head or the second clamp head.

Yet another embodiment of the disclosure is a method of measuring a load on a cylindrical component. The method may comprise the steps of:

(a) mounting at least two strain sensing elements to the cylindrical component;

(b) applying a load to the cylindrical component;

(c) simultaneously sensing a substantially pure tensile strain at a first of the strain sensing elements and a substantially pure compressive strain at a second of the strain sensing elements in response to a diametral change in the cylindrical component as effected by the load; and

(d) converting the sensed strains to a value equal to the load applied to the shaft.

These and other aspects of the present invention will become apparent to those skilled in the art after a reading of the following description of the preferred embodiments when considered in conjunction with the drawings. It should be understood that both the foregoing general description and the following detailed description are exemplary and explanatory only and are not restrictive of the invention as claimed.

### BRIEF DESCRIPTION OF THE DRAWINGS

According to common practice, the various features of the drawings discussed below are not necessarily drawn to scale. Dimensions of various features and elements in the drawings may be expanded or reduced to illustrate more clearly the embodiments of the disclosure.

FIG. 1 is an isometric view of a strain measuring device in an installed configuration according to an embodiment of the present disclosure;

FIG. 2 illustrates an isometric view of an embodiment of the strain measuring device of the present disclosure;

FIG. 3 illustrates a second isometric view of the embodiment illustrated in FIG. 2;

FIG. 4 illustrates a plan view of a portion of the embodiment of FIG. 2 showing a passage of the strain measuring device element in greater detail;

FIG. 5 illustrates an isometric view of a portion of the strain measuring device of FIG. 2, where the outer surfaces of the device are translucent for illustrative purposes and clarity only;

FIG. 6 is an exploded isometric view of a first support assembly and a second support assembly of the strain measuring device as disclosed herein; and

FIG. 7 is a schematic drawing of an electrical circuit for strain sensing elements that may be used with the strain measuring device.

### DETAILED DESCRIPTION OF THE EMBODIMENTS

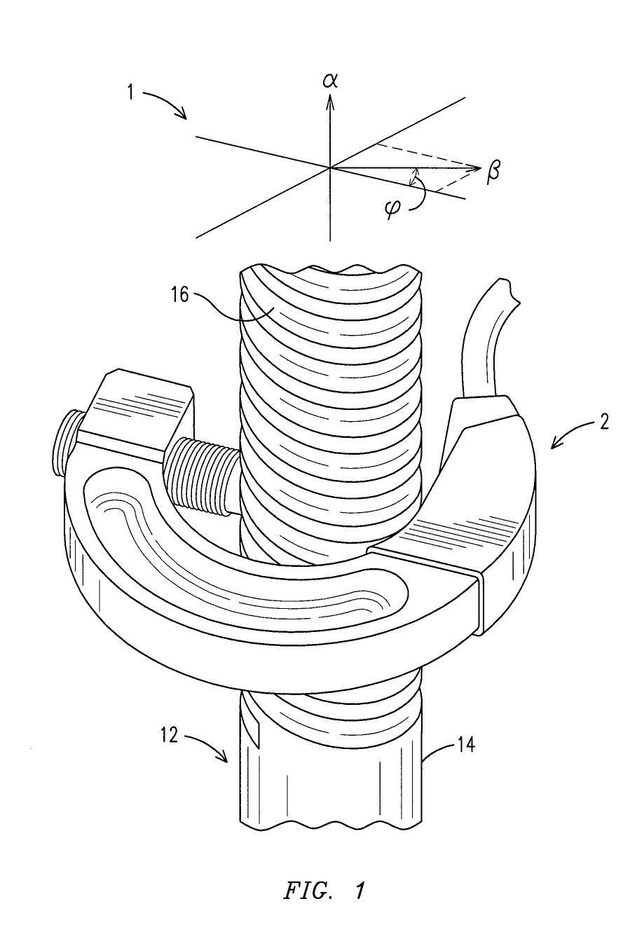

For clarity of discussion, the following three directional definitions and coordinate system are commonly used when discussing a strain measuring device as discussed herein and are used throughout this application and applicable to all embodiments disclosed herein. A cylindrical coordinate system 1 has a longitudinal axis “α,” radial axis “β,” and a circumferential axis “φ.” “Longitudinal” refers to a longitudinal axis “α” oriented in a direction parallel to a longitudinal axis of a shaft 12. “Radial” refers to a direction orthogonal to the longitudinal direction and to a radial axis “β” oriented in a direction extending outward from the longitudinal axis. “Circumferential” refers to an angular axis “φ” or direction that orients the radial axis “β” relative to either of the two reference axes 3, 4 perpendicular to the longitudinal axis α. Collectively, the three directional axes α, β, φ establish the cylindrical coordinate system 1. For purposes of the present disclosure, the longitudinal direction α generally refers to a direction along the shaft 12 and the lateral direction β generally refers to a direction extending from the center of the shaft 12 (See for example the “directional vane” adjacent FIG. 1 of the drawings).

Referring now in more detail to the drawing figures, wherein like reference numerals indicate like parts throughout the several views, FIG. 1 illustrates a strain measuring device 10, according to one embodiment of the disclosure, in an installed position relative to a cylindrical shaft 12, such as, for example, a valve stem for a motor operated valve or an air operated valve that may be found in a nuclear power plant or other facility. The strain measuring device 10 need not be limited in use to cylindrical shafts, and may be adapted for use on a component of any shape to obtain strain measurements. The strain measuring device 10 may operate with a principle similar to a diametral extensometer, in which a diametral expansion or contraction of the cylindrical shaft 12 may be converted to a linear strain and/or stress via the strain measuring device 10. The cylindrical shaft 12 may comprise a portion 14 having a smooth outer surface and a portion 16 having a threaded outer surface. The strain measuring device 10 may be suited for use on either or both types of surface 14, 16.

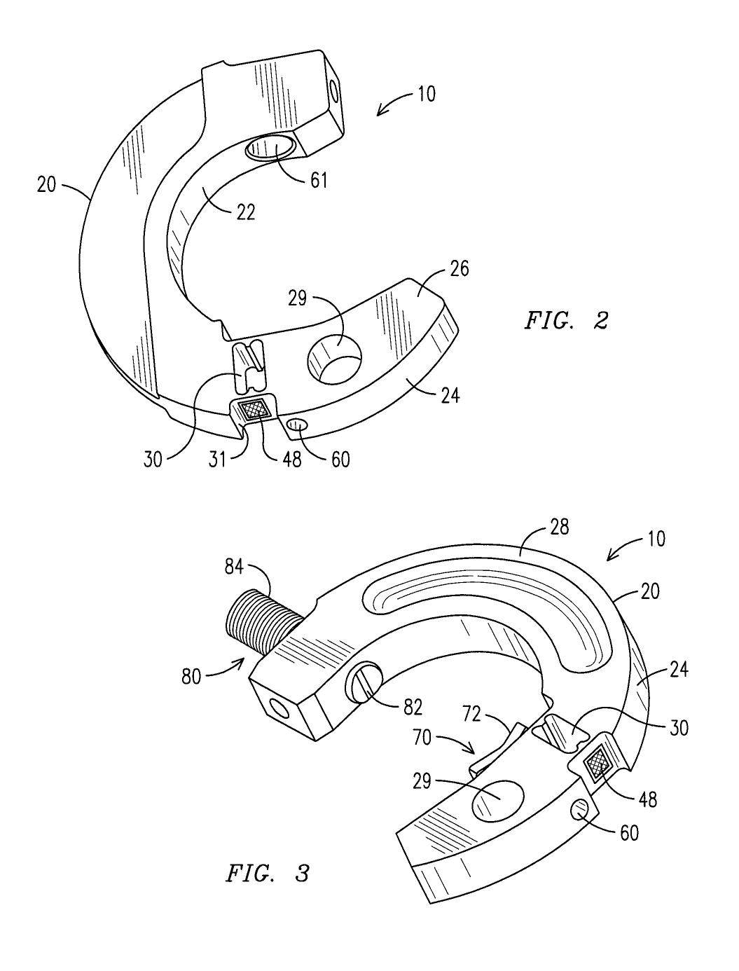

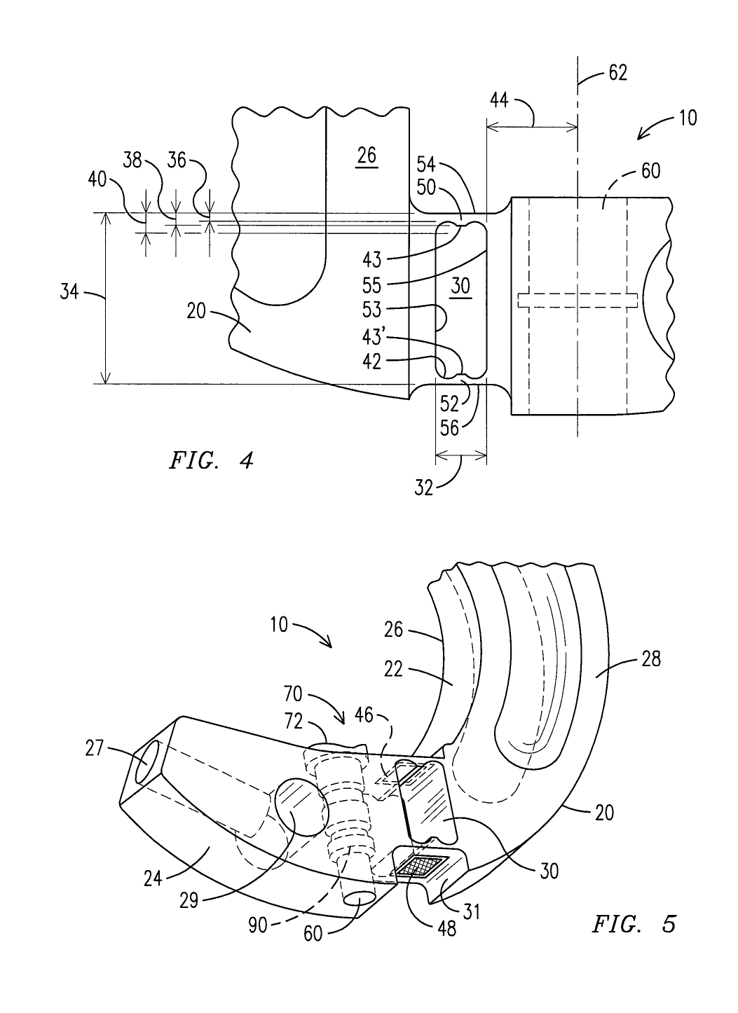

With reference to FIGS. 2-6, FIGS. 2 and 3 are isometric views of an embodiment of the strain measuring device 10 according to the present disclosure. The strain measuring device 10 has a body or frame 20 that may be generally arcuate in shape. It is not required that the body 20 be arcuate in shape and the body 20 may be any shape necessary to facilitate attachment of the device 20 to the component 12 to measure a strain in the component 12. In this particular embodiment, the body 20 is generally “C” shaped and has an inner surface 22, an outer surface 24 and generally parallel and planar first and second side surfaces 26, 28. However, there is no requirement that the body 20 be arcuate or “C” shaped and other shapes may be suitable. For example, the body 20 could be “U” shaped or channel shaped. In exemplary embodiments, the body 20 includes at least a concave portion with an axis of rotation (with reference to the cylindrical coordinate system 1, the axis of rotation would be the longitudinal axis α and rotated in the circumferential direction φ) about which the arcuate and concave inner surface 22 is defined. The concave, inner surface 22 is defined with a surface height that extends parallel to the axis of rotation α, as in a partial cylinder wall. The generally “C” shaped body 20 may facilitate installing the strain measuring device 10 on a generally cylindrical component 12. The inner surface 22 and outer surface 24 may be considered to extend in the circumferential direction cp when viewed relative to the cylindrical coordinate system 1 and the side surfaces 26, 28 may be generally perpendicular to the inner and outer surfaces 22, 24. In some embodiments, a channel or recess 31 may be machined or fabricated in the outer surface 24 of the body 20 and extend into the body 20. The recess 31 may increase the local flexibility of the body 20. In some embodiments, a channel or recess 33 (See FIG. 4) may be machined or fabricated in the inner surface 22 of the body 20 and extend into the body 20. The body 20 may have a port 29 arranged toward one end of the body 20. The port 29 at least functions as a passageway for electrical leads or other equipment to connect with at least two strain sensing elements 46, 48. The port 29 may extend through the body 20 but this is not a requirement and the port 29 may exit only one side (either the first side 26 or the second side 28) of the body 20. As most clearly seen in FIG. 5, a cable feed 27 extends from a face of the body 20 to the port 29 and intersects with the port 29. The cable feed 27 functions as a conduit for a cable 17 (See FIG. 1) containing the electrical leads to conveniently connect with strain sensing elements 46, 48. A passage 30 extends through the body 20, from the first side surface 26 to the second side surface 28 and the strain sensing elements 46, 48 are arranged proximate the passage 30. A first support assembly interface 60 is arranged on one side of the body 20 and a second support assembly interface 61 is arranged on an opposite side of the body 20. Centerlines 62 of the first support assembly interface 60 and the second support assembly interface 61 are collinear and extend along the longitudinal axis α. The fact that the centerlines 62 of the first support assembly interface 60 and the second support assembly interface 61 are collinear may more effectively transfer diametral strain from the component 12 to the body 20 of the strain measuring device 10. A first support assembly 70 communicates with the body 20 via the first support assembly interface 60 and an adjustable second support assembly 80 communicates with the body 20 via the second support assembly interface 61. In the depicted embodiment, the first support assembly interface is a generally smooth bore and the second support assembly interface 61 is a threaded bore.

FIG. 4 provides a more detailed illustration of one embodiment of the passage 30. The passage 30 provides a means of “tuning” the sensitivity of the body 20 of the strain measuring device 10 to detecting strain. The passage 30 must be located along the body 20 between the support assemblies 70, 80 in order to measure the change in a diameter of the component being measured or tested. This is because the body 20 is placed in a state of strain as a result of the change in component diameter. In some embodiments, it is preferred that the passage 30 be arranged in the body 20 to be near the first support assembly interface 60 or the second support assembly interface 61. Arranging the passage 30 near the first support assembly interface 60 or the second support assembly interface 61 may at least improve the performance of the strain sensing elements 46, 48. The passage 30 can be properly sized by adjusting several parameters or dimensions (discussed below) of the passage 30 to increase the sensitivity of the body 20 proximate the passage 30 to strain and enhance the ability of the strain measuring device 10 to detect diametral strain changes in the component 12. This is in part due to the increased flexibility of the body 20 of the strain measuring device 10 proximate the passage 30. A general concept of the strain measuring device 10 is the placement of the passage 30 in the body 20 to increase the level of strain developed in portions of the body near the passage (i.e. webs 50, 52). Further, the passage functions in part to reduce errors introduced by thermal effects the strain measuring device 10 may experience. This may be because a mass of the body 20 has been removed to form the passage 30 and reduces sensitivity to thermal loading with the passage 30 being arranged between the strain sensing elements 46, 48. This arrangement of the passage 30 between the strain sensing elements 48, 48 may be beneficial because it helps reduce cross-heating of one sensing element by another. Overall, the sensitivity and stability of the strain measuring device 10 may be improved because of the increased sensitivity and response of strain sensing elements 46, 48 arranged near the passage 30. Strain measuring device drift may also be reduced. Thus, another general concept of the strain measuring device 10 is to place the strain sensing elements 46, 48 on opposite sides of the passage 30 to reduce errors introduced by drift arising from thermal heating enhanced by the strain sensing elements 46, 48. “Drift” is caused by inherent limitations of the analogue circuits and drift is understood to mean a bias caused by a gradual and unintentional change in the reference value with respect to which measurements are made over time.

The passage 30 may be generally rectangular in shape or cross-section, wherein the cross-section is the cross-section in planar view, i.e. when viewed in the plane of the first side surface 26 or the second side surface 28. In other embodiments, the passage 30 may be square, circular, oval, polygonal, or any other cross-section that provides an appropriate strain field in the passage 30. An appropriate strain field is understood to be a strain field that is sensitive to diametral changes in the component and can be measured with a specified accuracy by the strain sensing elements 46, 48. The passage 30 is bounded on the inside and outside by an inner web 50 and a outer web 52, respectively, and by first and second side walls 53, 55. The inner web 50 may lie in a first plane and the outer web 52 may lie in a second plane and the first and second planes may be generally parallel to one another and generally perpendicular to a common centerline (i.e. centerline 62). The passage 30 may have a passage width 32 that is the distance between first and second side walls 53, 55. The passage 30 has a passage height that is the distance between interior surfaces of the webs 50, 52. The inner web 50 has a web thickness 38 that is the distance from an inner web contact surface 54 to a ridge 43 and the ridge extends a distance 38 from the inner web contact surface 54. The ridge 43 may function to make the strain in the inner web 50 more constant over the web 50. The outer web 52 also has a web thickness, which is the distance from a outer web contact surface 56 to the ridge 43′. The ridge 43′ may function to make the strain in the outer web 52 more constant over the web 52. The distance between the inner web contact surface 54 and the outer web contact surface 56 is given by 34. Each of the corners of the generally rectangular passage 30 may have a fillet 41. As illustrated, each fillet 41 has the same fillet radius 42. However, it is not required that each fillet 41 have the same fillet radius 42 and in some embodiments, each fillet radius 42 may be different. A fillet edge is spaced a distance 36, for example, from the inner web contact surface 54. The fillet 41 in part functions to reduce a local stress that may develop at a stress concentration that generally occurs at a corner. The second side wall 55 is spaced a distance 44 from a centerline 62 of the first support assembly interface 60. Strain sensing elements 46, 48 are arranged on the inner web contact surface 54 and outer web contact surface 56, respectively. The inner web contact surface 54 and outer web contact surface 56 and the strain sensing elements 46, 48 may be sized so the strain sensing elements 46, 48 cover a majority of their respective web contact surface 54, 46 to at least obtain a more accurate measurement of the local strain in their respective webs 50, 52. The strain sensing elements 46, 48 may measure the strain associated with the flexing of the body 20. The strain measuring elements 46, 48 will be subjected to bending and placed in substantially pure tension and substantially pure compression, respectively. Thus, another general concept of the strain measuring device is placement of the strain sensing elements 46, 48 on the body 20 so one of the strain sensing elements 46 may measure a substantially pure tensile strain and one of the strain sensing elements 48 may measure a substantially pure compressive strain. In some embodiments, the magnitude of tensile strain measured by the strain sensing element 46 may be approximately the same as the magnitude of compressive strain measured by the strain sensing element 48 during component 12 testing.

Strain sensing elements 46, 48 may have measuring axes that are generally tangent with the circumferential direction cp. When the strain measuring device 10 is fabricated, the first strain sensing element 46 may be installed and configured to be compressively loaded and the second strain sensing element 48 may be installed and configured to be loaded in tension. One reason for such an installation is so when the strain measuring device 10 is installed, the strain measuring device 10 can be adjusted so the first strain sensing element 46 and the second strain sensing element 48 produce a reading of “zero” strain prior to any component testing or monitoring.

Several of the dimensions or parameters of the passage 30 may be adjusted to improve the sensitivity and stability of the strain measuring device 10. Adjusting the passage width 32, the distance 36 from the inner web contact surface to the upper fillet radii 40 (as well as the corresponding distance from the outer web contact surface to the lower fillet radii), the fillet radius 42, and the distance 44 from the centerline 62 of the first support assembly interface 60 to the second side wall 55 of the passage 30. The skilled artisan will understand that adjusting the size of the passage may mean adjusting the sensitivity of the strain sensing elements 46, 48 by increasing the deformation in the webs 50, 52. These parameters 32, 40, 42, 44 are but a few of the possible parameters or dimensions that may be adjusted. Other viable parameters that may be adjusted will be any parameter that significantly affects the local strain in the webs 50, 52. Thus, another general concept of the strain measuring device 10 is the adjustment of several dimensions of the passage 30 to increase the strain in the webs 50, 52 to improve the ability of the strain sensing elements 46, 48 to measure said strain. The dimensions of the passage 30 may be adjusted to produce a large value of strain in the webs 50, 52 while remaining below the elastic limit of the material. The elastic limit of the material will be understood by the skilled artisan to be the maximum stress or force per unit area that can arise within the material before the onset of permanent deformation. When stresses or strains up to the elastic limit are removed, the material resumes its original size and shape.

As an example, and not meant to limit the scope of the present disclosure in any way, the following table, Table 1, provides example ranges of several of the passage dimensions.

TABLE 1

| Dimension | Minimum (inches) | Maximum (inches) |
|---|---|---|
| 32 | 0.126 | 0.130 |
| 36 | 0.170 | 0.190 |
| 38 | 0.024 | 0.032 |
| 40 | 0.045 | 0.053 |
| 42 | 0.027 | 0.035 |
| 44 | 0.236 | 0.244 |

As another example, the ranges for dimensions listed in Table 1 above may have the following discrete values: dimension 32 may be 0.130 inches; dimension 36 may be 0.180 inches; dimension 38 may be 0.028 inches; dimension 40 may be 0.049 inches; dimension 42 may be 0.031 inches; and dimension 44 may be 0.240 inches.

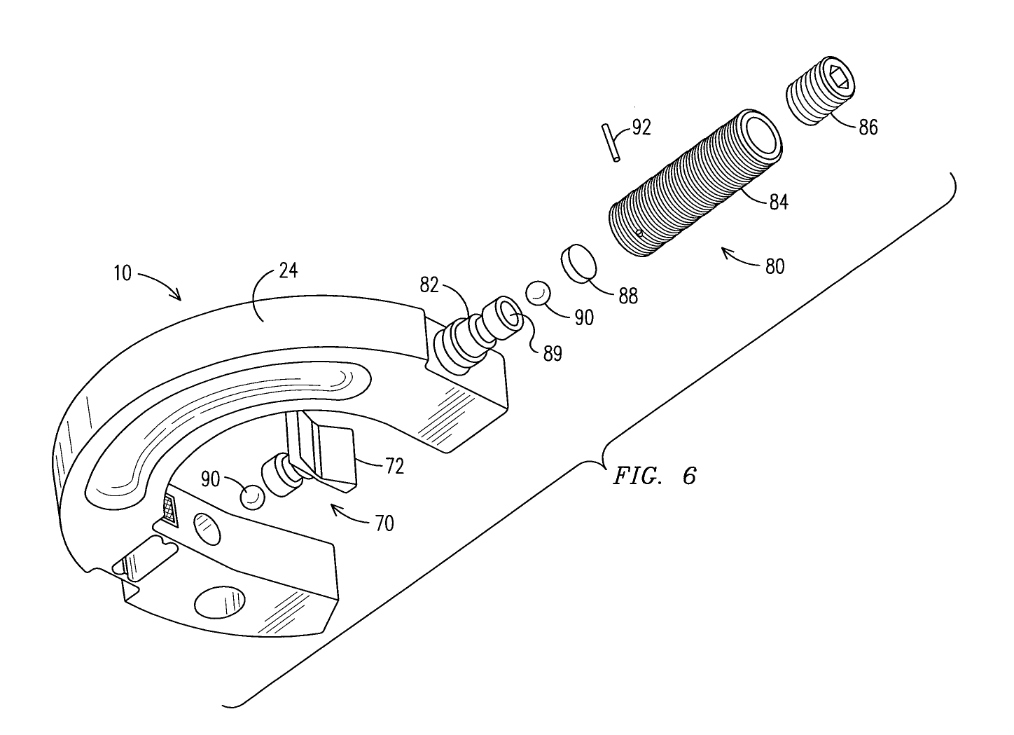

FIG. 6 is an exploded isometric view of the first support assembly 70 and the adjustable second support assembly 80. The support assembly 70 and the adjustable second support assembly 80 secure the strain measuring device 10 to the shaft or component 12 and facilitate “zeroing” the strain sensing elements 46, 48. In the disclosed embodiment, only the second support assembly 80 is adjustable. However, in other embodiments, both the support assembly 70 and the second support assembly 80 may be adjustable.

Support assemblies 70, 80 are mounted at opposite sides of the body 20 and secure the strain measuring element 10 to a component (See, for example, shaft 12 of FIG. 1) to be monitored or tested. The support assemblies 70, 80 may be in mechanical communication with the body 20 at interfaces 60, 61, respectively. The component will generally be cylindrical, such as a shaft, with loading applied in a direction parallel to the longitudinal axis α. The support assemblies 70, 80 can contact an outer surface of the component and are adjusted so the support assemblies 70, 80 are firmly attaching the strain measuring device 10 to the component.

The first support assembly 70 may be comprised of a support element 72. The support element 72 may include a “vee” type head element 73. The “vee” type head element 72 may be easier to align with the component 12, especially if the component 12 is cylindrical. The “vee” of the head element 73 may be oriented so a vertex of the “vee” is parallel with the longitudinal axis α and thus parallel to the component longitudinal axis. In some embodiments, a ball bearing may be included to improve device 10 alignment with respect to the component 12. The second support assembly 80 generally comprises a support element 82, a threaded spindle 84, a set screw 86, a plate 88, a retaining pin 92 and a ball bearing 90. The support element 82 may include a “vee” type head element 83 (See FIG. 3). Further, the support element 82 may be interchangeable with support element 72. The set screw 86 is threaded into and secured within the threaded spindle 84 to facilitate turning or adjusting the threaded spindle 84 during installation of the strain measuring device 10 with the component 12. The plate 88 is installed within a counter-bore (not shown) of the threaded spindle 84 and rests on an interior surface of the counter-bore of the threaded spindle 84. The plate may be manufactured from any hard material such as a metal or plastic. The ball bearing 90 is inserted within the counter-bore and rests against the plate 88. The ball bearing 90 is supported in a ball bearing cavity 89 on an end of the support element 82. The ball bearing 90 may facilitate alignment of the support element 82 relative to the component 12 and facilitate rotation of the threaded spindle 84 when adjusting the second support assembly 80. The retaining pin 92 is installed through a hole 93 extending through a portion of the threaded spindle 84. When the retaining pin 92 is installed in the hole 93, the ball bearing 90 will remain in place within the counter-bore of the threaded spindle 84.

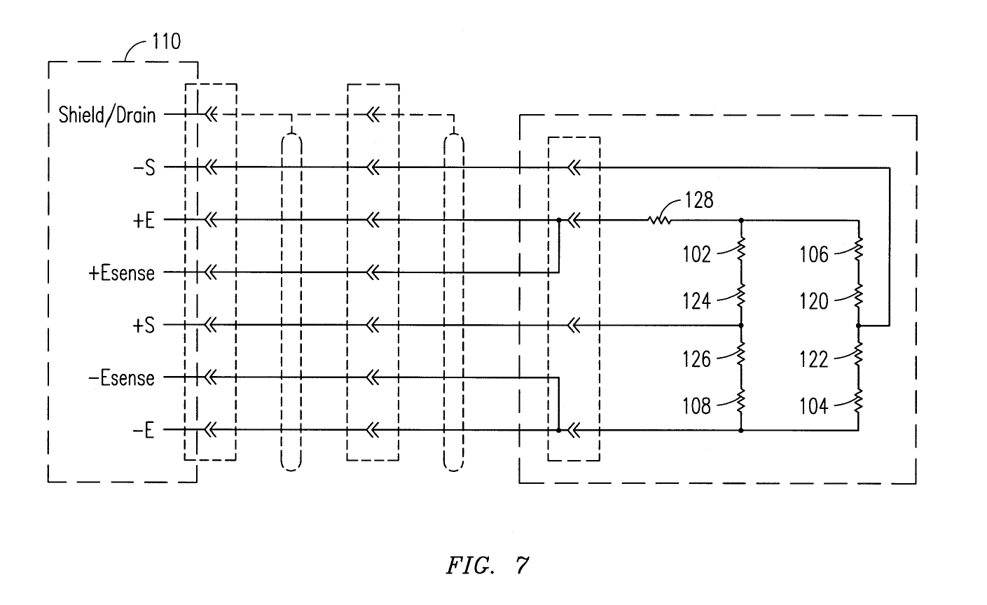

FIG. 7 is a schematic drawing of an electrical circuit of strain sensing elements 46, 48 that may be used with strain measuring device 10. Strain sensing element 48 may comprise gauges 102 and 104, which are gauges 102, 104 that sense compressive strains. Strain sensing element 46 may comprise gauges 106 and 108, which are gauges 106, 108 that sense tensile strains. Gauges 102 and 104 may be mounted on a substrate (not shown) and physically mounted to outer web 52. Gauges 102 and 104 may be mounted on a substrate (not shown) and physically mounted to inner web 50. Strain sensing element 48 may further comprise a resistor 120 that may be used to apply a pre-load to gauges 102, 104 and a resistor 124 to reduce some of the effects of thermal drift. Strain sensing element 46 may further comprise a resistor 122 that may be used to apply a pre-load to gauges 106, 108 and a resistor 126 to reduce some of the effects of thermal drift. Resistor 128 functions to correct a slope of a calibration curve that may be developed during calibration of the strain measuring device 10. As the gauges sense changes in a diameter of the component 12, the gauges 102, 104, 106, 108 produce electrical signals (i.e. voltages) that are proportionate to the amount of change of diameter (i.e. diametral strain) sensed. These electrical signals are transmitted to a data acquisition system 110 where they may be stored and evaluated.

The strain measuring device 10 can be manufactured from any suitable material including steel and steel alloy. Preferably, the device is manufactured from titanium. The material for the strain measuring device 10 should be selected with environment and duty cycle in mind to ensure sufficient mechanical and thermal properties to operate properly as well as respond properly to the load condition. The strain measuring device 10 can be fabricated using any acceptable fabrication method such as machining, casting, or forging. The device 10 may be fabricated from a plurality of different materials if desired.

Generally, the component or shaft 12, such as, for example a valve stem, experiences tensile and compressive loads while moving, for example, a valve head through a range of motion. Other examples of tensile and compressive loads on a shaft are evident to one skilled in the art. When the tensile or compressive load is applied to the shaft 12, the diameter of the shaft will either decrease or increase, respectively. The strain measuring device 10 measures the change in diameter of the shaft 12. From this measurement, an algorithm can determine the load being applied to the shaft 12 and how the load is being applied, i.e. the cyclic nature of the load as well as the magnitude of the load. As the diameter either increases or decreases, the body 20 of the strain measuring device 10 will flex either outward or inward, respectively. The term “flex” used throughout this document will be understood by the skilled artisan to mean a deformation of the body 20, with the body ends moving towards each other or away from each other. Strain sensing elements 46, 48, such as strain gauges, are attached to the strain measuring device 10 and measure the changes in the body 10, and are then related to the changes in the diameter of the shaft 12, and the load being applied to the shaft 12 can be determined.

In use, the strain measuring device 10 is first mounted to the shaft 12 that is to be monitored or evaluated. The strain measuring device 10 is secured to the shaft 12 by rotating the threaded spindle 84 of the second support assembly 80 to firmly contact the shaft 12. The strain measuring device 10 is properly aligned relative to the shaft 12 when the plane that is occupied by the two support elements 70, 80 is approximately perpendicular to the longitudinal axis a of the shaft 12. This is necessary because the arrangement of the strain sensing elements 46, 48 will be measuring tensile and compressive strains in the body 20 induced by the diametral changes of the shaft 14 during shaft loading. The second support element 82 should be advanced toward the component 12 so the head elements 73, 83 of the support assemblies 70, 80 clamp onto the shaft 12. The second support element 82 should be further advanced to increase the strain in the body 20 until the strain sensing elements 46, 48 are reading approximately zero strain. The strain measuring device 10 is now “zeroed.” When the shaft 12 is loaded along the longitudinal axis α, the diameter of the shaft 12 will either increase or decrease. For example, if the load applied along the longitudinal axis α is compressive, the shaft diameter will increase as a result of the compression. Thus, when the diameter of the shaft 12 increases, a flexing force will be applied to the body 20 at the support elements 70, 80 and cause the body 20 to flex or bend. Because of the design of the passage 30 and the action of the head elements 73, 83, upon mounting to shaft 12, a tensile strain may be developed in the inner web 50 and a compressive strain may be developed in the outer web 52. With the tensile and compressive strain measurements from strain elements 46, 48, the load applied along the longitudinal axis a can be determined and the mechanical integrity of the shaft 12 evaluated.

Certain modifications and improvements will occur to those skilled in the art upon a reading of the foregoing description. It should be understood that all such modifications and improvements have been deleted herein for the sake of conciseness and readability but are properly within the scope of the following claims.

I claim:

1. A device for measuring strain in a component comprising:
a rigid frame;
a first contact assembly arranged on the frame;
a second contact assembly arranged on an opposite end of the frame;
a passage that extends through the frame and along an axis that is substantially parallel with a longitudinal axis, the passage arranged between the first contact assembly and the second contact assembly, wherein
an inner web is defined between the passage and an inner surface of the frame and an outer web is defined between and an outer surface of the frame and the passage; and
at least a first strain sensing element contacting either the inner web or the outer web.

2. The device as claimed in claim 1, further comprising a second strain sensing element contacting the web not contacted by the first strain sensing element.

3. The device as claimed in claim 1, wherein the frame has a pair of substantially flat and parallel side surfaces, each side surfaces extending in a plane approximately perpendicular to the longitudinal axis.

4. The device as claimed in claim 3, wherein a measuring axis of the strain sensing elements is along an axis perpendicular to the longitudinal axis and approximately parallel with a circumferential axis.

5. The device as claimed in claim 4, wherein the passage is substantially rectangular in cross-section.

6. The device as claimed in claim 5, wherein the passage has at least one arcuate fillet at each corner of the passage.

7. The device as claimed in claim 2, wherein the first strain sensing element measures a tensile diametral strain of the component and the second strain sensing element measures a compressive diametral strain of the component.

8. The device as claimed in claim 2, wherein the second strain sensing element measures a tensile diametral strain of the component and the first strain sensing element measures a compressive diametral strain of the component.

9. The device as claimed in claim 1, wherein the frame is an arcuate shaped frame.

10. The device as claimed in claim 9, wherein the frame is a “C” shaped frame.

11. The device as claimed in claim 1, wherein the adjustable first contact assembly the second contact assembly each comprise a “V” shaped contact element.

12. The device as claimed in claim 1, wherein the adjustable first contact assembly is adjusted to produce a strain in the frame having a predetermined value.

13. The device as claimed in claim 1, wherein the first strain sensing element is arranged on an outer surface of the inner web or an inner surface of the inner web.

14. The device as claimed in claim 1, wherein the second strain sensing element is arranged on an outer surface of the outer web or an inner surface of the outer web.

15. The device as claimed in claim 1, wherein the first contact assembly and the second contact assembly cooperate to align the frame relative to the component and secure the frame to the component.

16. The device as claimed in claim 2, wherein, wherein the first and second strain sensing elements measure a change in diameter in the component.

17. A device for measuring strain comprising:
a frame having an outer surface, an inner surface spaced from the outer surface in a radial direction, and a planar first side surface generally parallel to and spaced from a planar second side surface;
a first support assembly arranged between the upper surface and the lower surface and a second support assembly arranged between the upper surface and the lower surface, wherein the first support assembly and the second support assembly are approximately opposite each other on opposing ends of the frame;
a passage extending from the upper surface to the lower surface and arranged between the inner surface and the outer surface and between the first support assembly and the second support assembly;
a first web established by the passage and between a passage inner surface and the inner surface of the frame and a second web established by the passage and between a passage outer surface and the outer surface of the frame; and
a first strain sensing element arranged on the first web and a second strain sensing element arranged on the second web, wherein the first strain sensing element measures a tensile strain and the second strain sensing element measures a compressive strain.

18. The device as claimed in claim 17, wherein the first and second side surfaces extend in respective planes generally perpendicular with a longitudinal axis.

19. The device as claimed in claim 17, wherein the frame is an arcuate frame.

20. The device as claimed in claim 17, wherein the device measures a diametral strain in a generally cylindrical component.

21. The device as claimed in claim 20, wherein the device measures strain in generally cylindrical components having a diameter ranging from 0.5 inches to 5 inches.

22. The device as claimed in claim 17, wherein the outer web is further defined by a recess extending from the outer surface to the outer web.

23. The device as claimed in claim 17, wherein the passage is a generally rectangular passage.

24. The device as claimed in claim 23, wherein a sensitivity of the passage is optimized by a optimizing at least one of a plurality of parameters selected from the group of parameters consisting of a passage width, a distance from a first web contact surface to upper fillet radii, fillet radii located at respective corners of the passage, a distance from a centerline of the support assemblies to a side wall of the passage, and combinations thereof.

25. The device as claimed in claim 17, wherein the first support assembly and second support assembly transfer a strain from a component to the frame.

26. A method of measuring a load on a cylindrical component, comprising:
(a) mounting at least two strain sensing elements to the cylindrical component;
(b) applying a load to the cylindrical component;
(c) simultaneously sensing a substantially pure tensile strain at a first of the strain sensing elements and a substantially pure compressive strain at a second of the strain sensing elements in response to a diametral change in the cylindrical component as effected by the load; and
(d) converting the sensed strains to a value equal to the load applied to the shaft.

27. The method as claimed in claim 26, prior to step (a) attaching the strain sensing elements to a respective inner web and outer web of a frame.

28. The method as claimed in claim 27, further comprising the step of mounting the frame to the cylindrical component.

29. The method as claimed in claim 28, further comprising the step of measuring a compressive strain at the strain sensing element attached to the outer web and measuring a tensile strain at the strain sensing element attached to the inner web.

30. A device for measuring a diametral change in a shaft produced by an axial loading of the shaft comprising:
a body defining a first mounting portion and a second mounting portion spaced apart and interconnected by a central body portion;
a first clamp head mounted to said first mounting portion, for engagement with a shaft;
a second clamp head mounted to said second mounting portion, for engagement with a shaft, and spaced from the first clamp head, said first clamp head and said second clamp head being aligned along and spaced apart along a common centerline, which centerline does not intersect said central body portion;
a passage extending through said central body portion and proximate either the first clamp head or the second clamp head, wherein a first web is defined between said passage and an inner surface of said body and a second web is defined between said passage and an outer surface of said body;
a first strain sensing element attached to said first web; and
a second strain sensing element attached to said second web.

31. The device as claimed in claim 30, wherein a diametral strain measured in a shaft to which the device is mounted is converted to a value representative of a load in the shaft.

32. The device as claimed in claim 30, wherein the first web is in a tensile strain state and the second web is in a compressive strain state when the device is uninstalled.

33. The device as claimed in claim 30, wherein said first web lies in a first plane and said second web lies in a second plane, said first and second planes being generally parallel to one another and being generally perpendicular to said common centerline.

34. The device as claimed in claim 30, wherein each of said first web and said second web is formed with a thickened ridge projecting into said passage and extending through said body and with thinner web walls adjacent each side of said ridge.

35. The device as claimed in claim 30, wherein said passage is located within a distance of less than one-half inch away from said common centerline.
